(19) United States
(12) Patent Application Publication
(10) Pub. No.: US 2018/0367644 A1
(43) Pub. Date: Dec. 20, 2018

(54) HIGH AVAILABILITY SOLUTION FOR FILE SHARING INVOLVING A CLIENT AND MULTIPLE SERVERS

(71) Applicants: Gary Howard Mckay, Camberwell (AU); Regan Jarrod Mckay, Glen Iris (AU)

(72) Inventors: Gary Howard Mckay, Camberwell (AU); Regan Jarrod Mckay, Glen Iris (AU)

(21) Appl. No.: 15/624,729

(22) Filed: Jun. 16, 2017

(51) Int. Cl. H04L 29/06; H04L 29/08

(52) U.S. Cl. CPC H04L 67/42; H04L 67/06

(57) ABSTRACT

System and methods for transferring metadata between a plurality of clients and servers, for transferring physical data between pluralities of servers, and for enabling incremental data synchronization of files. Through those methods, a secure mechanism of sharing and synchronization of data at all times is realized irrespective of a plurality of link or device failures between the said clients and servers.

### SECTION 1.0 BACKGROUND

The applicant has developed a cloud file sharing and synchronization software suite product to manage business data across a variety of end-user devices including Bring Your Own Devices (BYOD) features for PCs, Macs, Servers, Smartphones and Tablets. The product intends to incorporate client-end local encryption of stored business data and usher in a new paradigm in cloud file sharing and synchronization innovation.

This applicant's developed product targets the entire global IT reseller industry—VARs (Value Added Resellers), MSPs (Managed Service Providers) and CSPs (Cloud Service Providers). This product will be sold as a software subscription (licenses per user (business employee)) for data sharing, synchronization and collaboration to VARs, MSPs and CSPs for them to on-sell to their business customer base—typically Small and Medium Enterprises (SMEs). The key value proposition of this product to the IT reseller industry is the generated high margin on sales as a consequence of the competitive SME end-user license pricing model for software subscription.

The IT reseller industry landscape typically comprises VARs (IT companies who typically provide IT and technical support to SMEs along with selling multiple types of branded hardware and software by adding their own margins); MSPs (IT companies who typically assist SMEs implement an IT operational strategy, provide proactive maintenance and support to SMEs along with selling multiple types of branded hardware and software) and CSPs (IT companies who typically provide cloud services such as website hosting, online backup, hosted email and virtual service to SMEs).

The applicant's developed product enables end-users the opportunity to choose their preferred data storage system as part of their own hardware located at their own premises (private cloud) as well as the ability to leverage upon a VAR/MSP/CSP's data storage along with their private data storage to create a highly scalable hybrid cloud.

One of the applicant's objectives is developing a secure, flexible, robust and cost-effective solution for business data control and sharing for end-user SMEs. Due to a high degree of proliferation of tablets and smartphones, end users (SMEs) unable to provide efficient, secure and scalable data sharing, synchronization and collaboration expose themselves to the risk of their staff and subcontractors using consumer products in the data sharing and collaboration space (e.g. Dropbox) on their own personal accounts for transferring and sharing business-related data. Due to legal and technical restrictions, SMEs do not have control over this process and significantly compromise their business continuity and operational risk. This developed product, along with enabling scalability in file sharing and synchronization across a wide variety of end-user devices, extend the notion of end-user security and control to BYOD (Bring Your Own Devices) for business data risk management.

### SECTION 2.0 HISTORY OF RELATED ART

### References Cited

U.S. Patent Document

| | | | |
|---|---|---|---|
| 8,131,739 | March | 2012 | Wu et al. |
| 7,529,811 | May | 2009 | Thompson |
| 8,332,942 | December | 2012 | Small |
| 7,987,204 | July | 2011 | Stokes |
| 8,640,232 | January | 2014 | Small |
| 2006/0129584 A1 | June | 2006 | Hoang et al. |
| 8,176,007 | May | 2012 | Hoang et al. |
| 8,751,639 | June | 2014 | Griffiths |
| 2013/0290385 A1 | October | 2013 | Morrey et al. |
| 8,055,613 | November | 2011 | Mu et al. |
| 7,689,598 | March | 2010 | Ching et al. |
| 8,489,548 | July | 2013 | Wang et al. |
| 2013/0031155 A1 | January | 2013 | Terrano et al. |
| 8,595,381 | November | 2013 | Long |
| 8,200,791 | June | 2012 | Callanan et al. |
| 2014/0013008 A1 | January | 2014 | Lazarus et al. |
| 2014/0040353 A1 | February | 2014 | Sebastian et al. |
| 2014/0067929 A1 | March | 2014 | Kirrigin et al. |
| 8,688,434 | April | 2014 | Birnbaum et al. |
| 2007/0130145 A1 | June | 2007 | Pedersen et al. |
| 6,374,268 | April | 2002 | Testardi |
| 7,634,507 | December | 2009 | Atluri et al. |
| 8,131,739 | March | 2012 | Wu et al. |
| 7,529,811 | May | 2009 | Thompson |
| 8,332,942 | December | 2012 | Small |
| 7,987,204 | July | 2011 | Stokes |
| 8,640,232 | January | 2014 | Small |
| 2006/0129584 A1 | June | 2006 | Hoang et al. |
| 8,176,007 | May | 2012 | Hoang et al. |
| 8,751,639 | June | 2014 | Griffiths |
| 2013/0290385 A1 | October | 2013 | Morrey et al. |
| 8,055,613 | November | 2011 | Mu et al. |
| 7,689,598 | March | 2010 | Ching et al. |
| 8,489,548 | July | 2013 | Wang et al. |
| 2013/0031155 A1 | January | 2013 | Terrano et al. |
| 8,595,381 | November | 2013 | Long |
| 8,200,791 | June | 2012 | Callanan et al. |
| 2014/0013008 A1 | January | 2014 | Lazarus et al. |
| 2014/0040353 A1 | February | 2014 | Sebastian et al. |
| 2014/0067929 A1 | March | 2014 | Kirrigin et al. |
| 8,688,434 | April | 2014 | Birnbaum et al. |
| 2007/0130145 A1 | June | 2007 | Pedersen et al. |
| 6,374,268 | April | 2002 | Testardi |
| 7,634,507 | December | 2009 | Atluri et al. |
| 9,251,114 | February | 2016 | Ankin et al. |

### SECTION 3.0 SUMMARY OF THE PRESENT INVENTION

This invention develops systems and methods for transferring metadata between a plurality of clients and servers, and for transferring physical data between pluralities of servers at all times. Through those methods, a secure mechanism of sharing and synchronization of data at all times is realized irrespective of a plurality of link or device failures between the said clients and servers.

### SECTION 4.0 BRIEF DESCRIPTIONS OF THE DRAWINGS

The foregoing summary, as well as the following description of the invention, is better understood when read with the appended drawings. For the purpose of illustrating the invention, there is shown in the drawings exemplary embodiments of various aspects of the invention. The invention is however not limited to the specific disclosed methods and instrumentalities.

In this invention, reference is made to CFS, an embodiment of methods and techniques realized in computer software. The definitions used in the below referenced diagrams include the following:

CFS Client is an embodiment of a client device (including but not limited to, computers, mobile phones, tablets, and any general system comprising electronic hardware and associated software in any form) with many-to-many connection capabilities.

CFS Link is an embodiment of representation of a physical file through a web link, with all operations on the said web link deemed as operations on the corresponding physical file, with file locking functionality and on-demand synchronisation features.

CFS Marketplace is pre-configured assortment of third party cloud storage made available for sale to the company via the CFS software management console.

CFS Server is an embodiment of a server device (including but not limited to, computers, mobile phones, tablets, and any general system comprising electronic hardware and associated software in any form) with many-to-many connection capabilities.

CFS ServerSync, within the scope of this invention, is a file synchronizing agent that is bidirectional with many-to-many connection capabilities.

FIG. 1 illustrates a general embodiment of this invention where CFS Server and CFS ServerSync are installed on the same server of an organizations' on premise IT infrastructure. CFS Client is installed on the remote user workstation as well as one of the local user workstations on premise.

FIG. 2 illustrates a general embodiment of this invention where CFS Server and CFS ServerSync are installed on separate servers of an organizations' on premise IT infrastructure. CFS Client is installed on a remote user workstation, a remote user Smartphone (typically in the form of a mobile app) as well as one of the local user workstations on premise.

FIG. 3 illustrates a general embodiment of this invention where CFS Server and CFS ServerSync are installed on separate servers by an organization. The CFS Server is installed on an organizations' off premise server. CFS ServerSync is installed on an organizations' on premise server. CFS Client is installed on two remote user workstations as well as one of the local user workstations on premise.

FIG. 4 illustrates a general embodiment of this invention where multiple CFS Servers are installed off premise of an organization. Such an embodiment could also encompass a cloud Storage Marketplace. CFS ServerSync is installed on the organizations' on premise server. CFS Client is installed on two remote user workstations as well as one of the local user workstations on premise.

FIG. 5 illustrates a general embodiment of this invention where multiple CFS Servers are installed off premise of an organization. Such an embodiment could also encompass a cloud Storage Marketplace. CFS ServerSync is installed on the organization's two on premise servers. CFS Client is installed on two remote user workstations as well as one of the local user workstations on premise.

FIG. 6 illustrates a general embodiment of this invention where a high availability (HA) solution is envisaged through the topology where all local workstations have CFS Client installed and are not connected to its replication site in the LAN. CFS Client will initiate connection to replication Server 2 if the connection to Server 1 is discontinued.

FIG. 7 illustrates a general embodiment of this invention where a high availability (HA) solution is envisaged through the topology where all local workstations have CFS Client installed and enables replication in the LAN.

FIG. 8 illustrates a general embodiment of this invention where multi-tier High Availability (HA) solutions are envisaged where all servers have CFS Server and all workstations have CFS Client installed. CFS Client will initiate connection to replication servers if the connection to Server 1 is discontinued.

FIG. 9 illustrates a general embodiment of this invention where connecting remote users to CFS Server based on high latency is envisaged.

### SECTION 5.0 DETAILED DESCRIPTION OF THE INVENTION

### Section 5.1 Introduction

The subject matter of this present invention is described with specificity to highlight the resolution of technical challenges faced in seamless data sharing through file sharing and synchronization over the cloud. The description itself is not intended to limit the scope of this patent. The inventors have contemplated that the claimed subject matter might also be embodied in other ways, to include different steps or combinations of steps similar to the ones described in this document, in conjunction with other present or future technologies.

### Section 5.2 Deploying Environment

The general deploying environment of the embodiments of this invention is a network topology consisting of IT infrastructure connected through the internet running over TCP/IP, as commonly used in the networking terminology. The storage spaces in concern are general storage devices commonly used in storing data in network topologies (e.g. storage server, hard disks, NAS devices et al.)

### Section 5.3 System Architecture

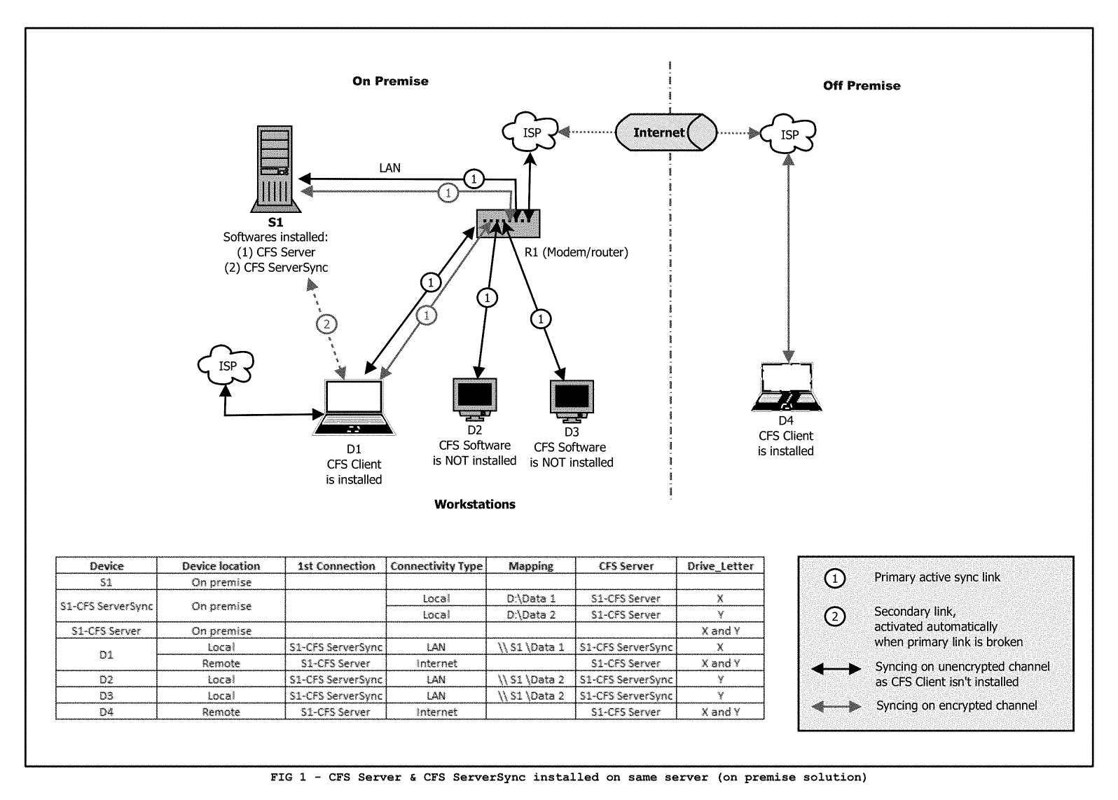

The embodiment illustrated in FIG. 1 highlights the file sharing and synchronization mechanism by installing CFS Server and CFS ServerSync on the same server in the premise of an organization. As illustrated, the CFS Server is installed on Server 1 that resides as part of the company's own IT infrastructure on its physical premises. Workstations D2 and D3 are located on the company premises that are standalone. CFS Client is installed on a local workstation D1 separately as illustrated. Outside the company premises, a remote user workstation D4 has CFS Client installed. Workstations D2 and D3 synchronize their data with Server 1 through the company's internal LAN. The local workstation D1 on the company premises synchronizes data with Server 1 typically through the company's internal LAN, or alternatively, in some embodiments, it can synchronize through the internet. The remote workstation D4 user outside the company premises synchronizes data with Server 1 through the internet.

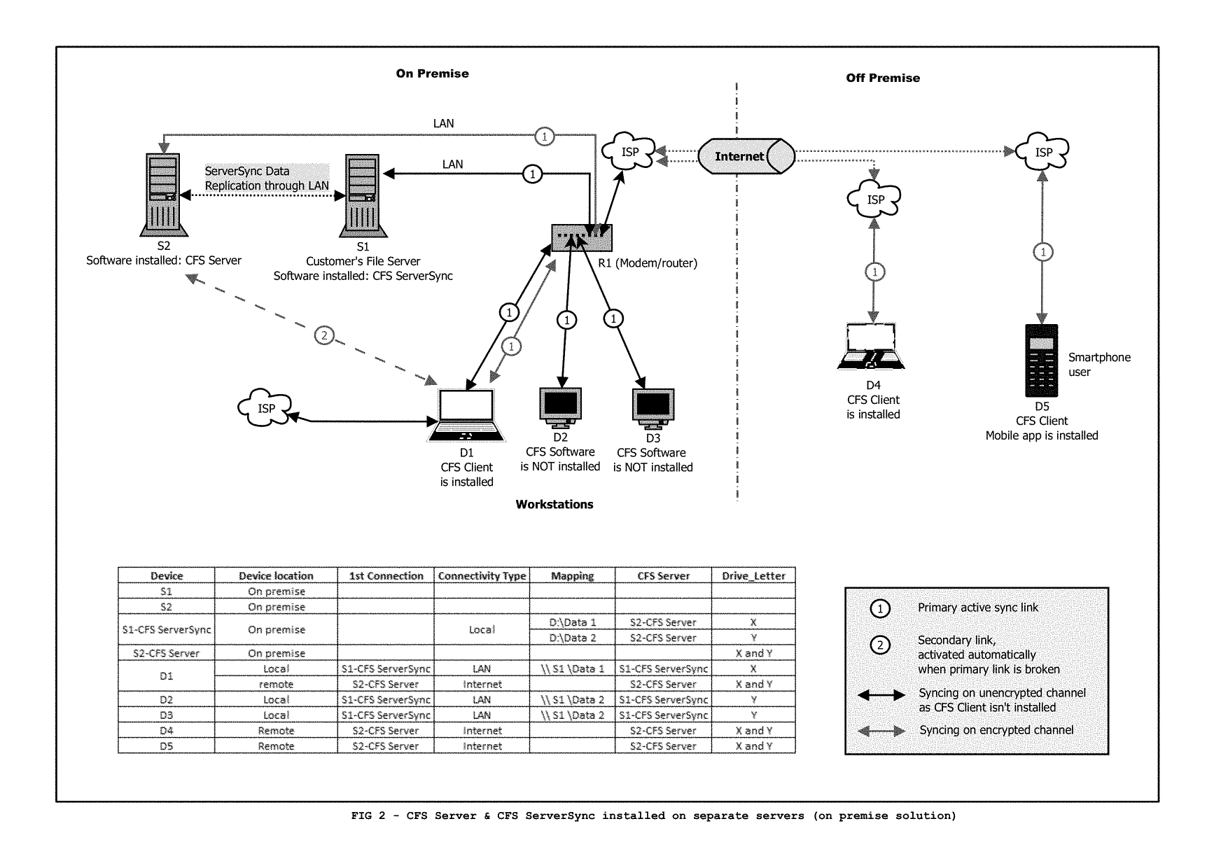

The embodiment illustrated in FIG. 2 highlights the file sharing and synchronization mechanism by installing CFS Server on a separate server in the premise of an organization. As described in the previous paragraph, the synchronization mechanism is similar to the embodiment illustrated in FIG. 1, the only notable difference being CFS Server being installed on Server 2 (the separate server) and CFS ServerSync being installed on Server 1 (the company's internal file server). CFS Client is installed on the remote workstation D4 and the Smartphone D5 which synchronizes data with the company's Server S2 through the Internet. The company's local workstations D2 and D3 synchronize data via the local LAN, with Server S1. Server S1 is synchronized with Server S2 through the company's internal LAN. Hence, the data synchronized to Server S1 can be available to the remote workstations D4 and D5 via Server S2.

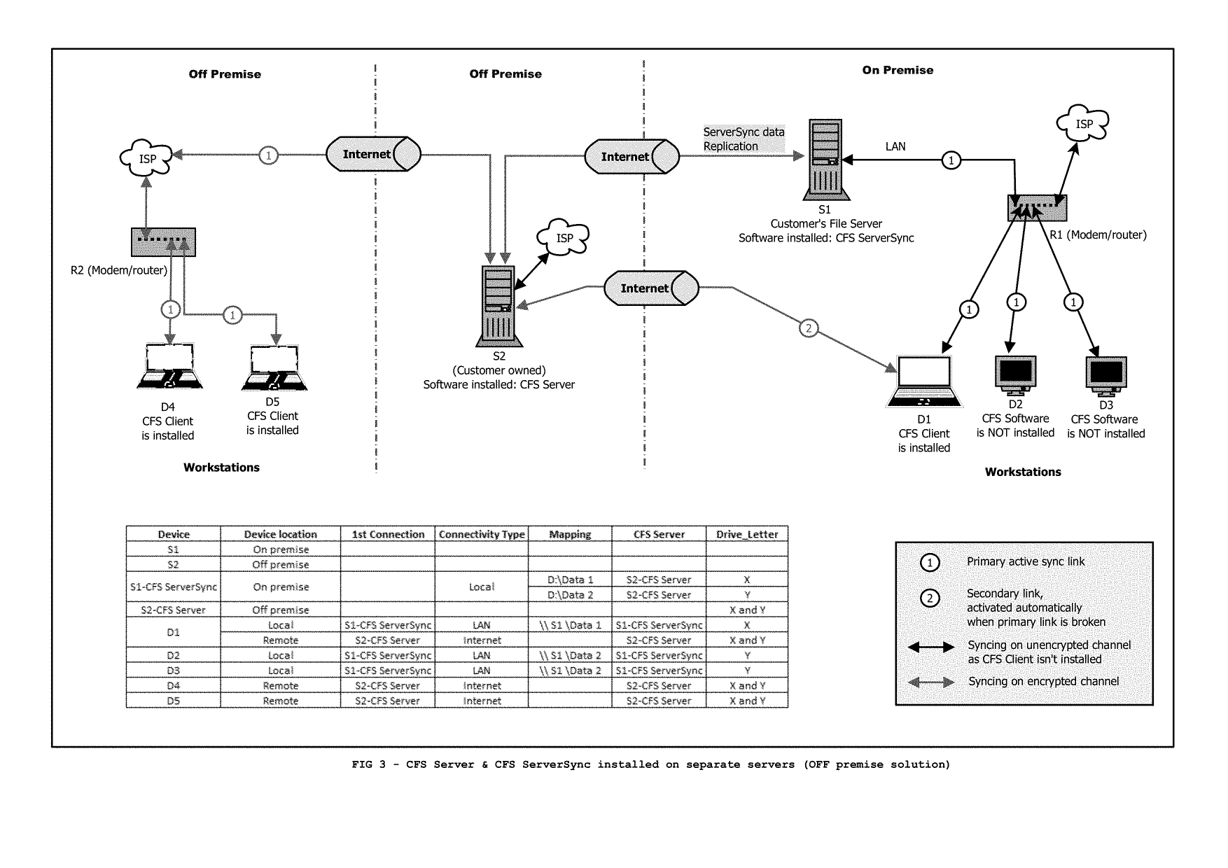

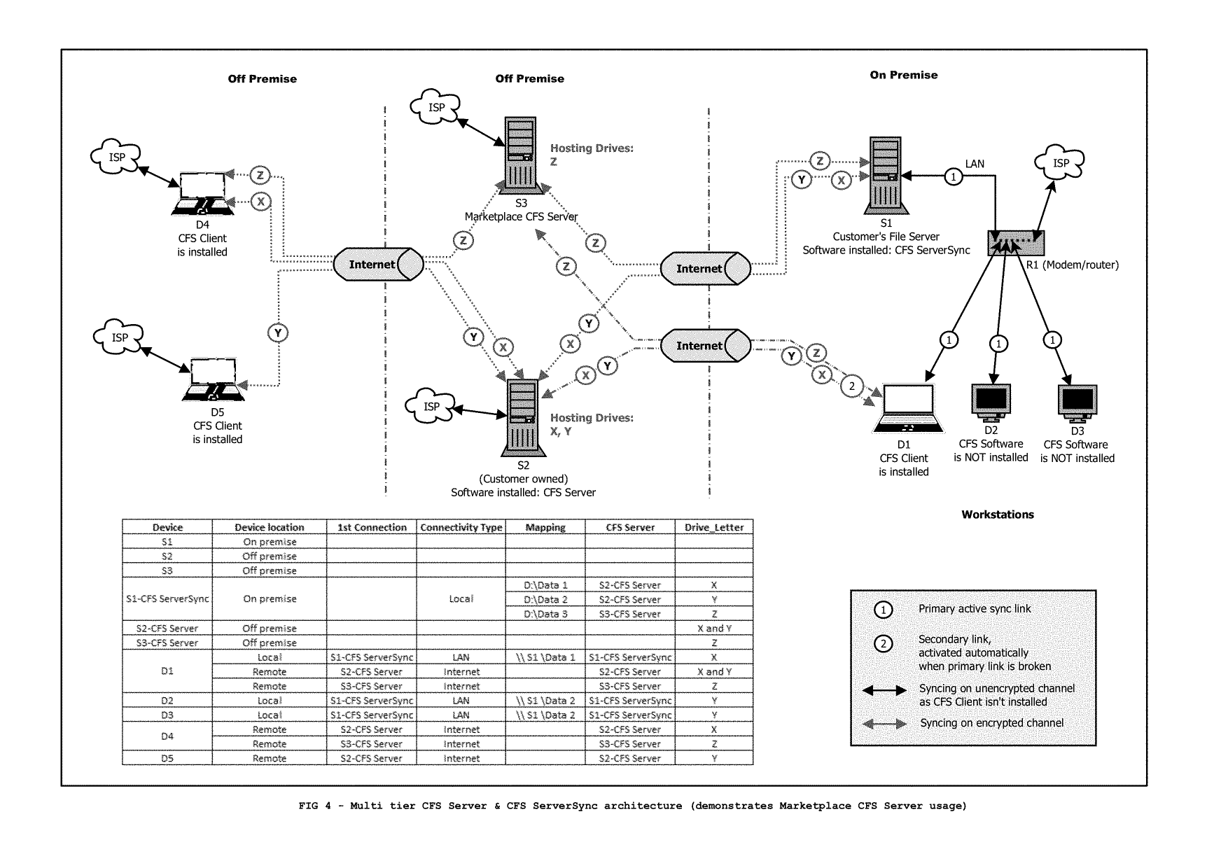

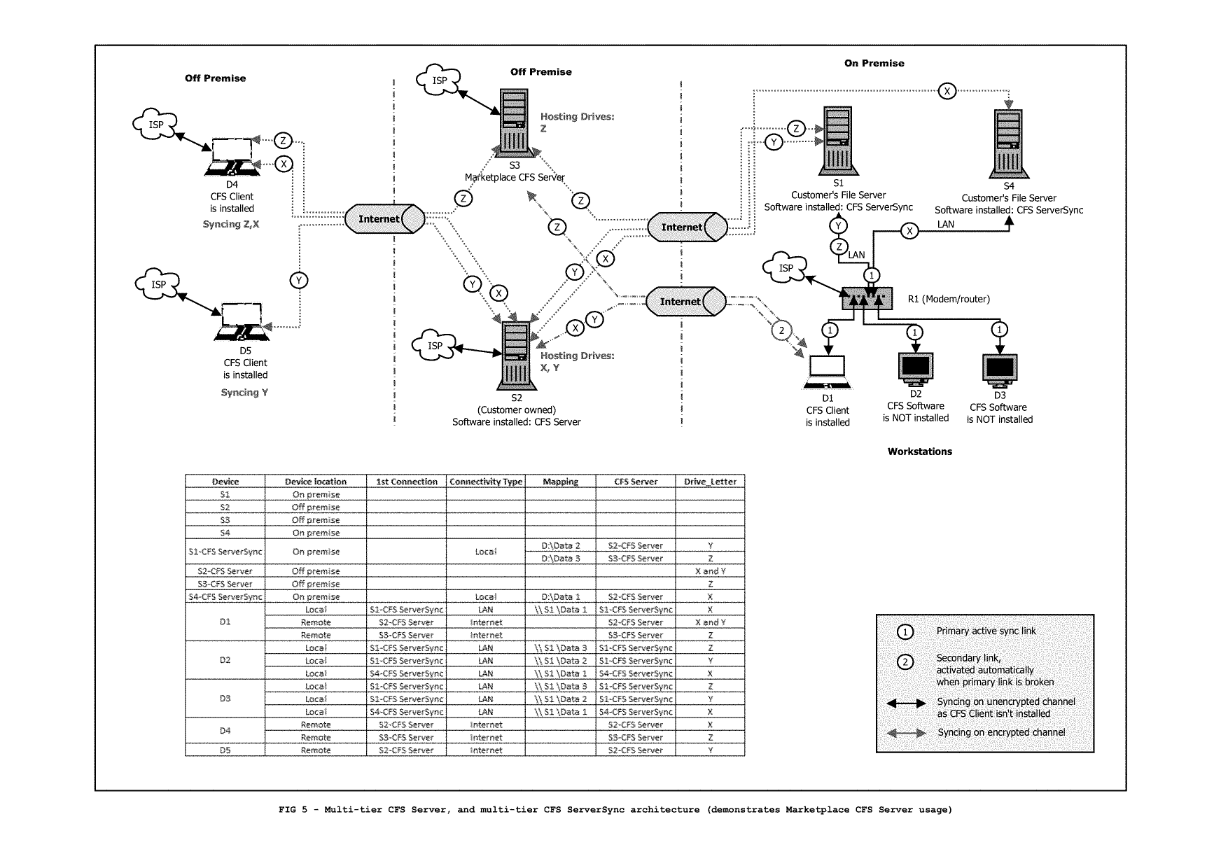

The embodiment illustrated in FIG. 3 highlights the file sharing and synchronization mechanism by installing CFS Server on the separate off premise Server S2. Within the company premises, the topology of the file server and local workstations is similar to the embodiment illustrated in FIG. 2. i.e. Server S1 has CFS ServerSync installed and Server S2 has CFS Server installed. The embodiment illustrated is similar to in FIG. 2, but with the Server S2 located off premise. The remote workstations D4 and D5, with CFS Client installed, are connected to the Server S2 via the internet. Synchronization between the S1 and S2 servers is also via the internet. Workstation D1 is primarily connected to Server S1 through the company internal LAN and secondarily connected to Server S2 though the internet. Workstations D2 and D3 are connected to Server S1 through the company's internal LAN.

The embodiment illustrated in FIG. 4 highlights the file sharing and synchronization mechanism utilizing third-party cloud storage selected from the CFS Marketplace. In this embodiment, the topology of the company with respect to local workstations and the file server are identical to the topology illustrated in FIG. 3 and discussed therein, and the topology involving the remote location with respect to workstations. The key innovation highlighted in this embodiment is the introduction of Server S3, which is cloud storage available from the CFS Marketplace. As illustrated in the figure, synchronization is done on the basis of drives created on different servers (e.g. Y:\ created on one remote workstation and X:\ and Z:\ created on the other remote workstation is synchronized through Server S2 (X:\ and Y:\) and through Server S3 (Z:\). These are further synchronized with the company's local workstations via the same mechanism that was discussed while describing the mechanism illustrated in FIG. 3.

The embodiment illustrated in FIG. 5 illustrates an extended scenario of the embodiment illustrated in FIG. 4, where the functional features as described and discussed in the said figure are referenced in absoluteness herein. The key novel feature in this topology is the introduction of the on premise Server S4, which has CFS ServerSync installed. CFS ServerSync is also installed on the on premise Server S1. As illustrated through the synchronization flows in FIG. 5, it can be understood how X:\, Y:\ and Z:\ are synchronized among one another. Workstations D2 and D3 synchronises Y:\ and Z:\ with Server S1 in the local LAN. Workstation D1 synchronises X:\ with Servers S2 and S4, Y:\ with Servers S1 and S2, and Z:\ with Servers S1 and S3. Using the internet, Server S4 synchronizes X:\ with Server S2, whereas Server S1 synchronizes Z:\ with Server S3 and Y:\ with Server S2. Workstation D4 synchronizes X:\ and Z:\ with Server S2 and Server S3 respectively, while workstation D5 synchronizes Y:\ with Server S2.

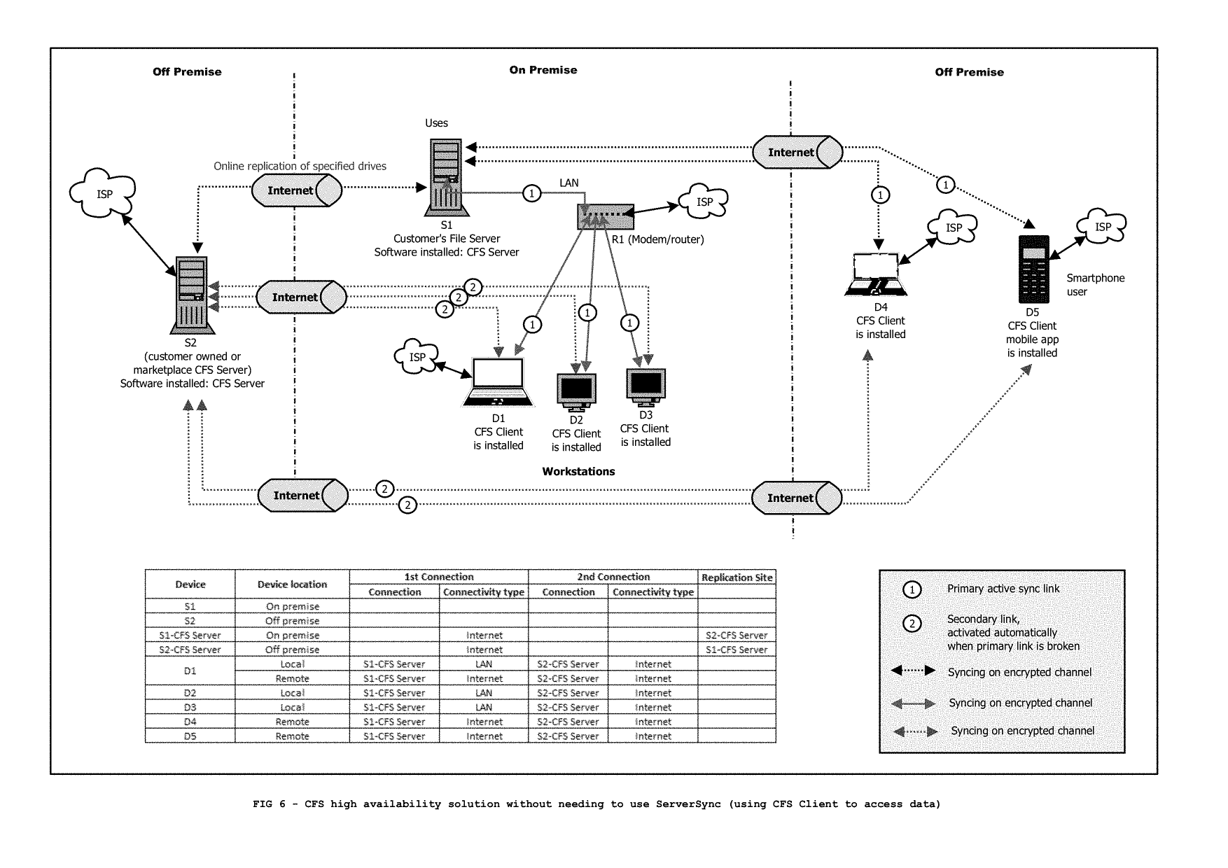

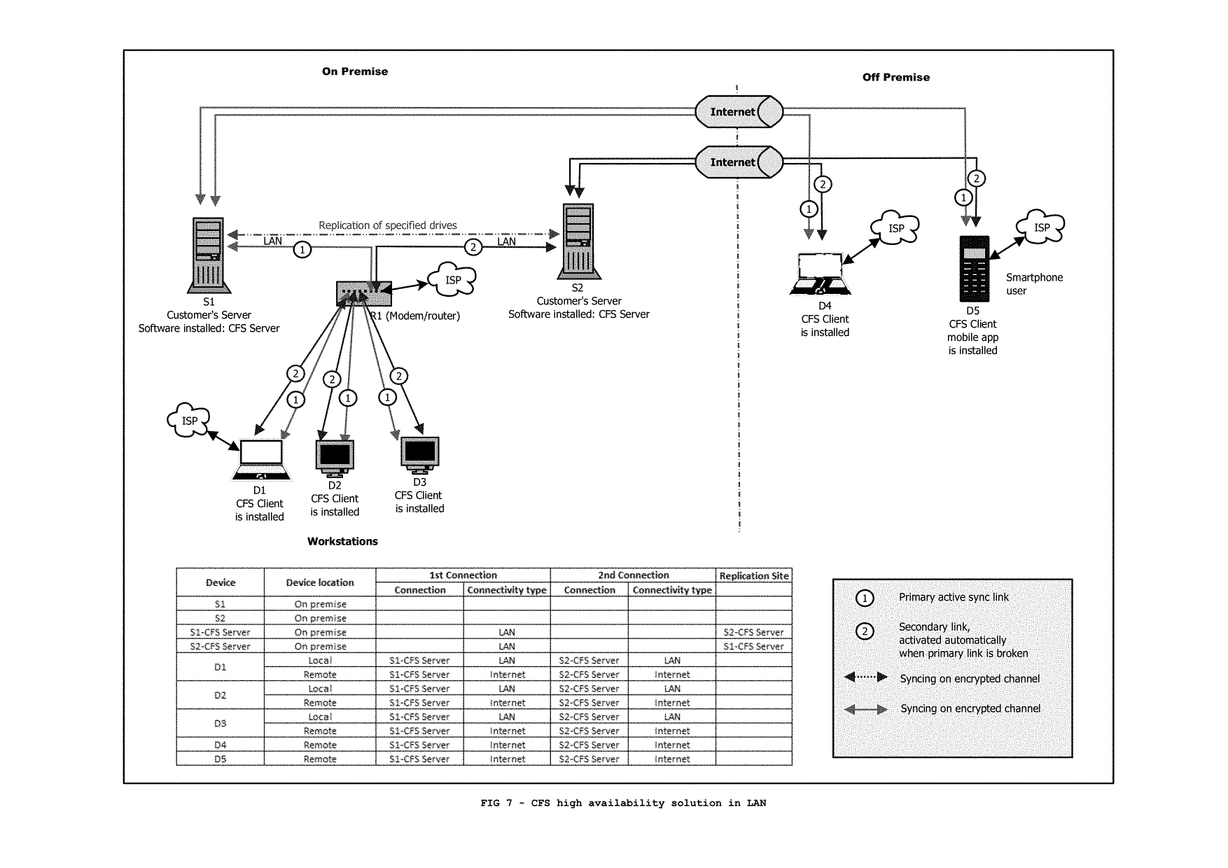

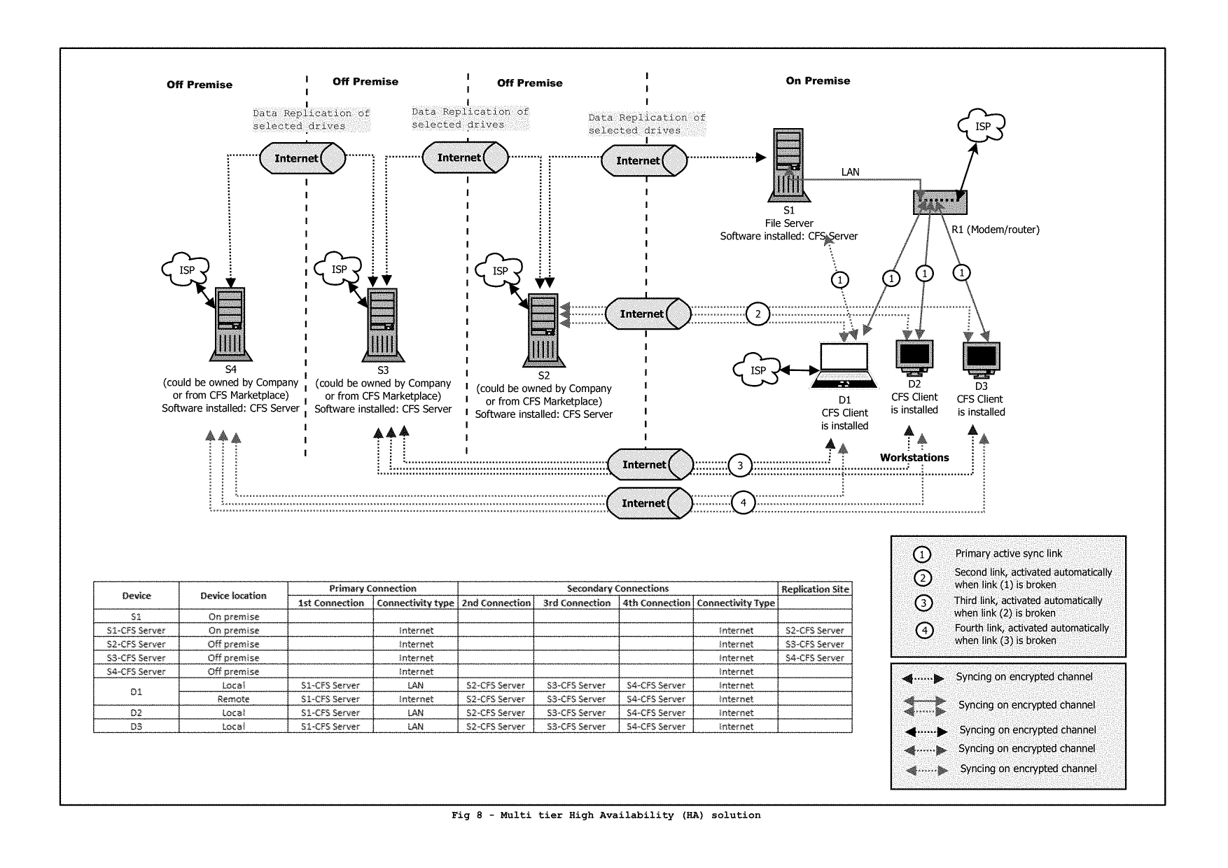

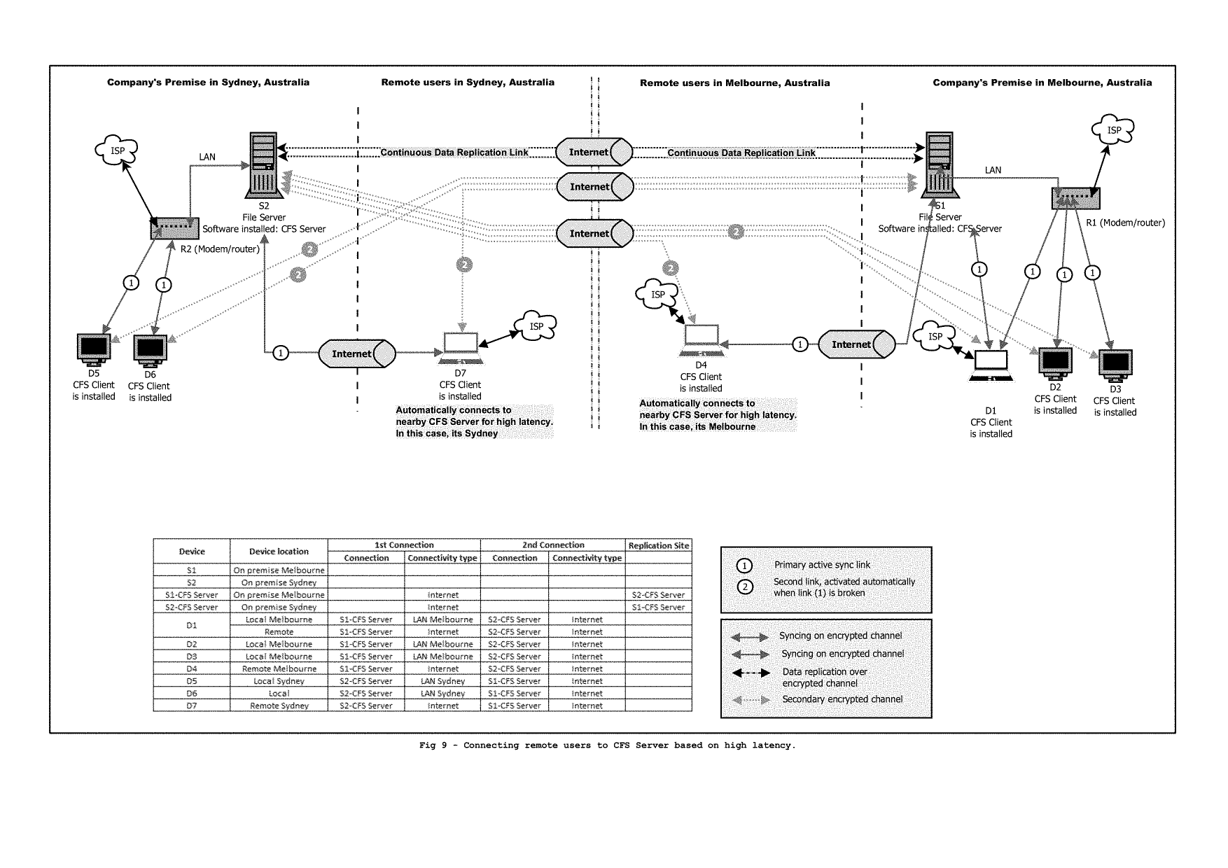

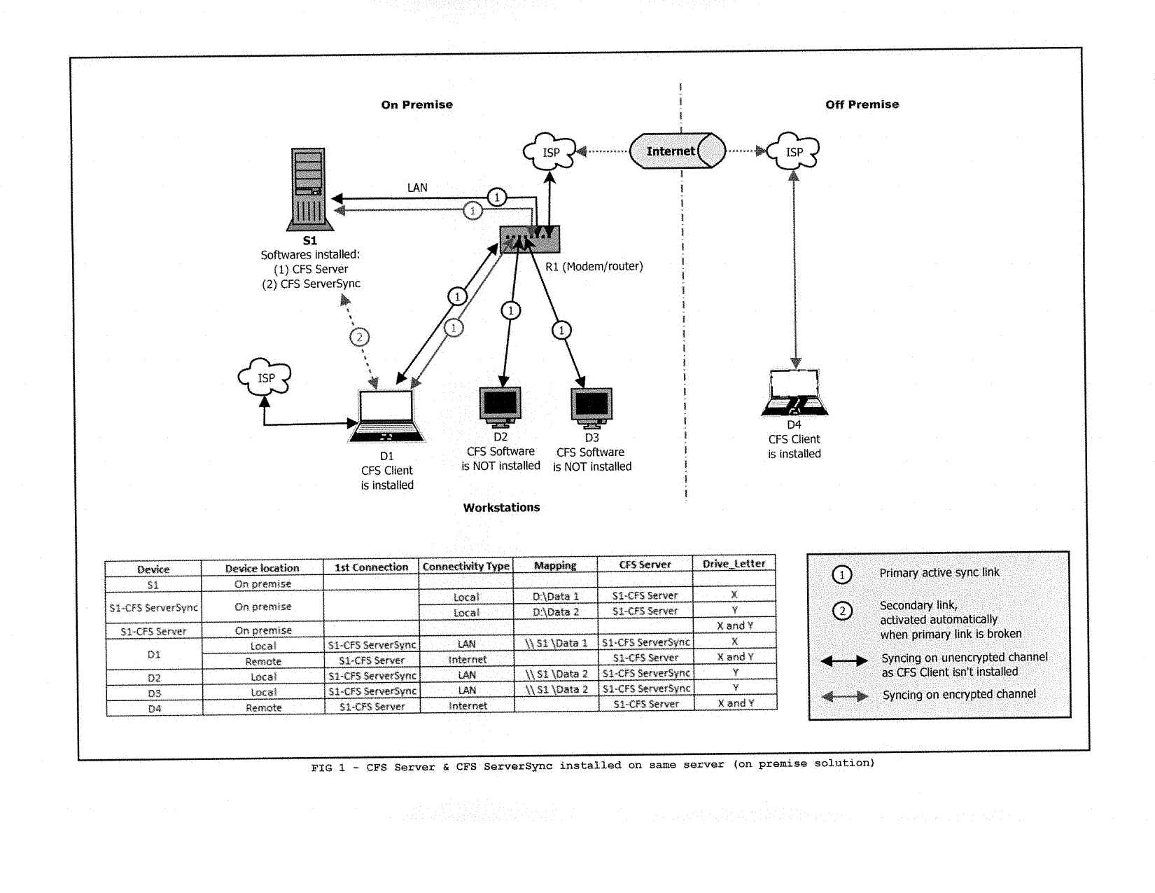

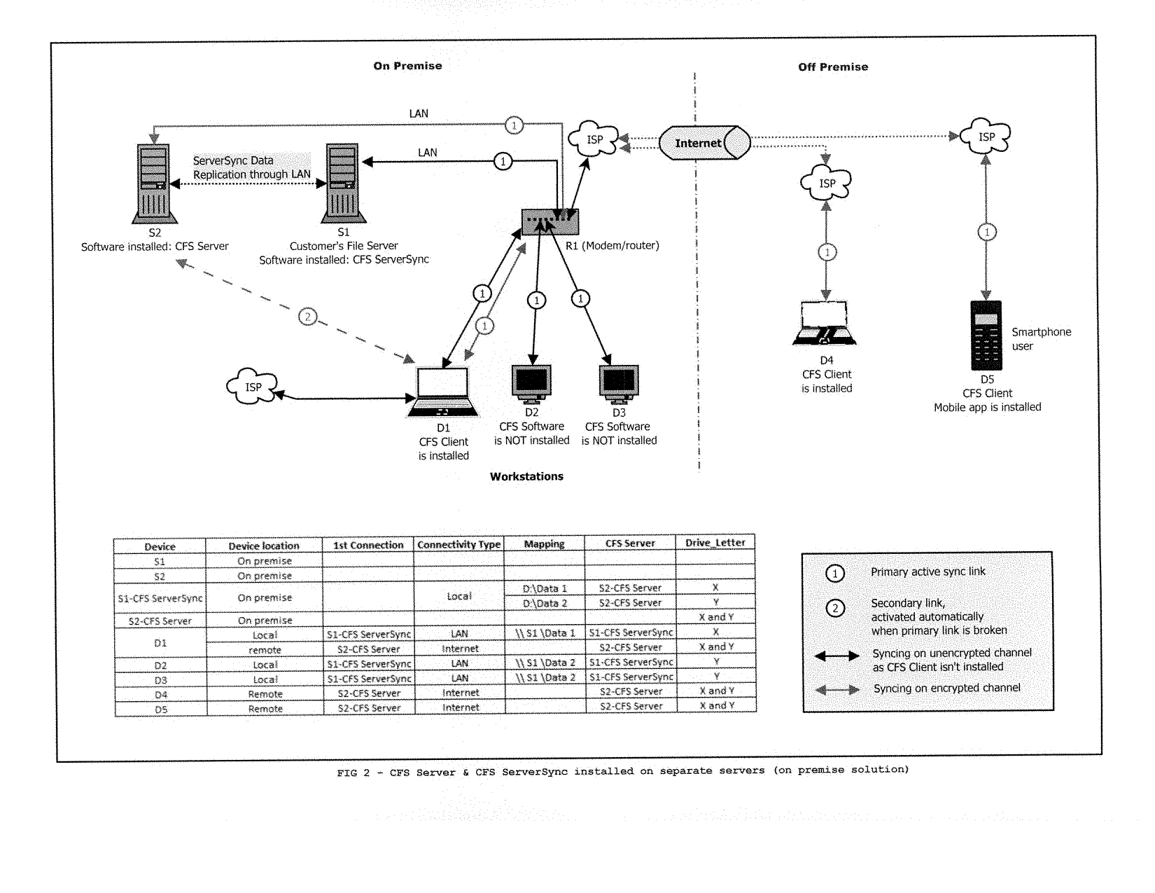

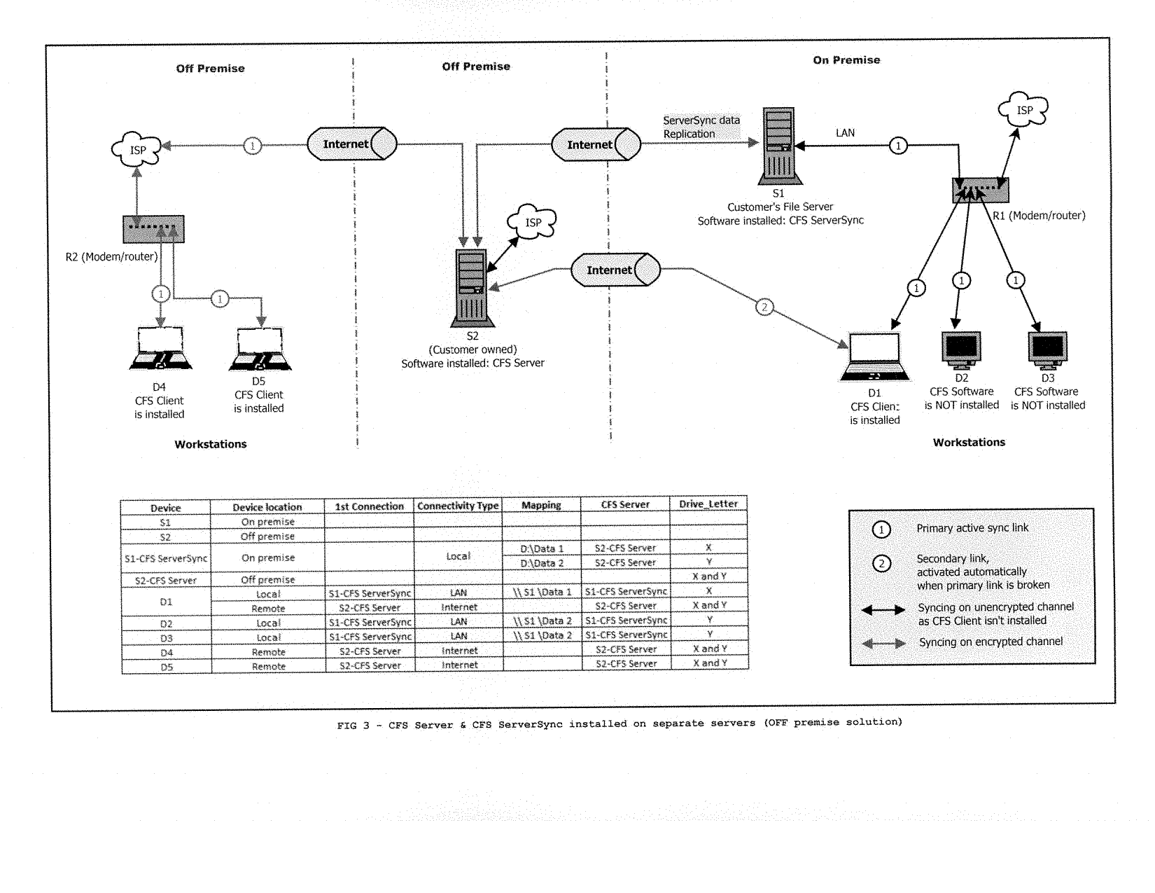

The embodiment illustrated in FIG. 6 highlights the High Availability (HA) file sharing and synchronization mechanisms through the use of a separate server in the scenario whereby the local workstations D2 and D3 are not connected to the off premise replication Server S2 in the LAN. The topology of the company with respect to workstations are identical to the topology illustrated in FIG. 3 and discussed therein, the only difference being that CFS Client is installed on all the local workstations D1, D2 and D3. CFS Client is also installed on remote workstation D4 and mobile app on the Smartphone D5. The local workstations D1, D2 and D3 constantly synchronize data with the on premise Server S1 through the company's internal LAN. CFS Server is also installed on the off premise replication Server 2. The data between the Server S1 and Server S2 is constantly synchronized. The notion is, that if the company's internal LAN fails, or any of the individual links between the company's local workstations D1, D2 or D3 and Server S1, then the local workstations D1, D2 or D3 will remain synchronized with the off premise replication Server S2 through the internet, thereby retaining synchronization and continuous data sharing irrespective of a break in communications link within the organization. Similarly, the remote workstation D4 and Smartphone D5 (typically through a mobile app) primarily synchronize with Server S1, with alternate secondary synchronization path to the replication Server S2, thereby providing synchronization and continuous data sharing irrespective of a break in communications link to Server S1.

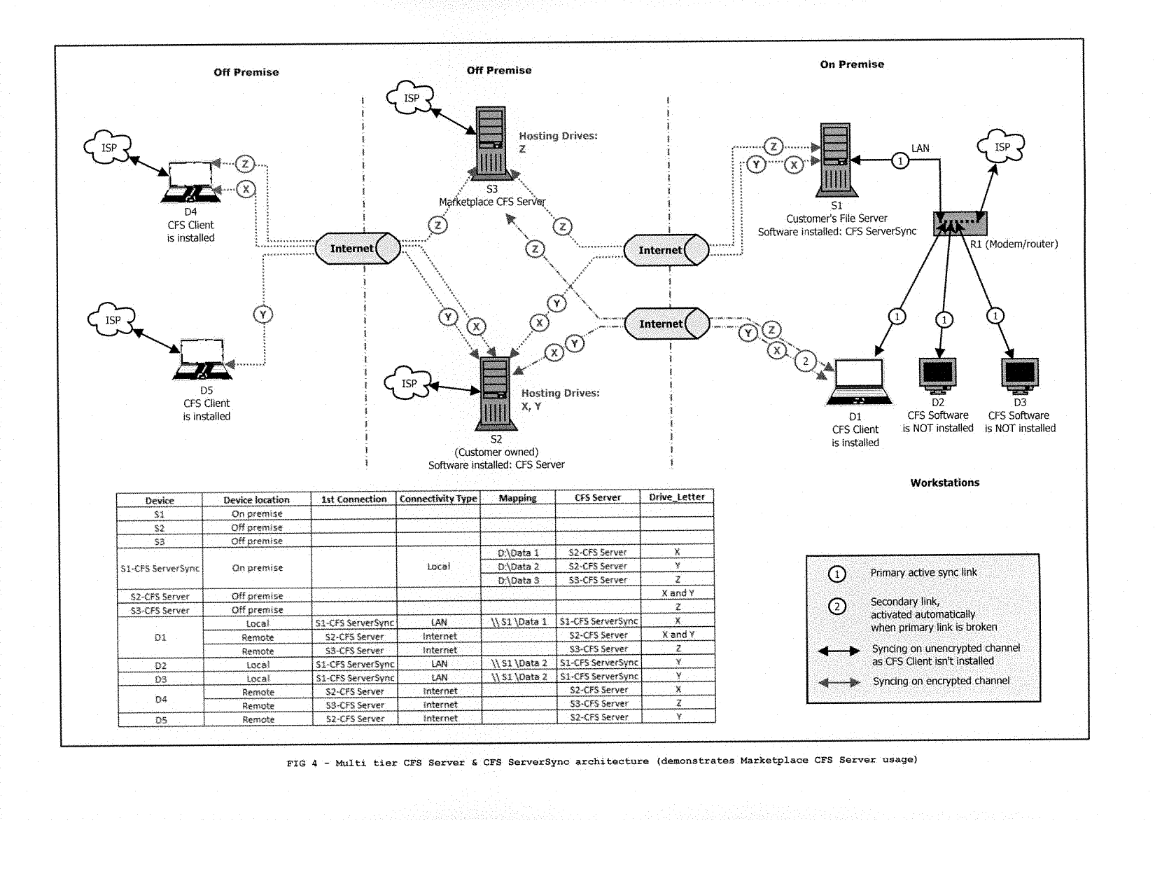

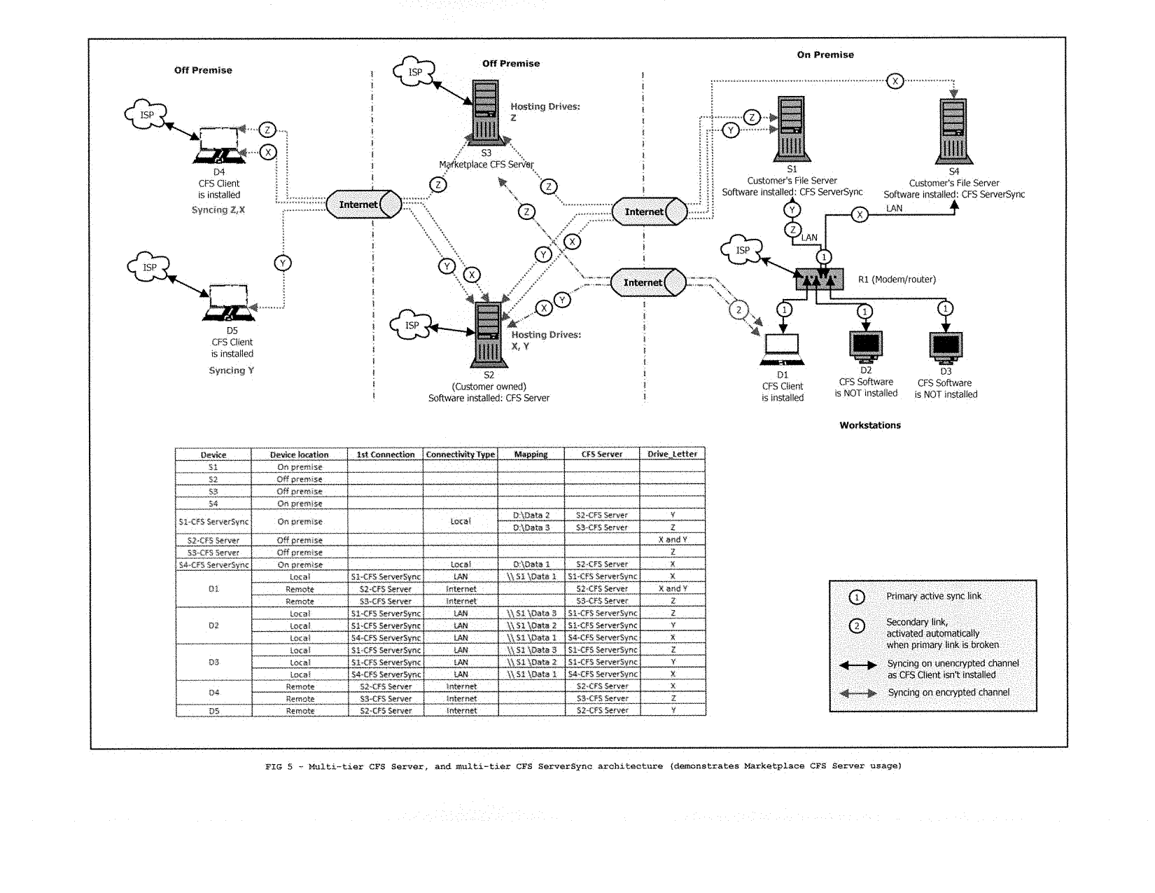

The embodiment illustrated in FIG. 7 highlights the High Availability (HA) file sharing and synchronization mechanisms through the installation of the replication server on premise. The topology of the company with respect to workstations are identical to the topology illustrated in FIG. 2 and discussed therein, the only difference being that CFS Client is installed on all the local workstations D1, D2 and D3. CFS Client is also installed on remote workstation D4 and mobile app on the Smartphone D5. Server S1 and Server S2 have CFS Server installed. The local workstations D1, D2 and D3 primarily synchronize data with on premise Server S1 in the LAN and secondarily synchronise with on premise replication Server S2 also in the LAN. The general embodiment of this invention is a high availability (HA) solution envisaged through the topology where all local workstations have CFS Client installed that enables replication in the LAN.

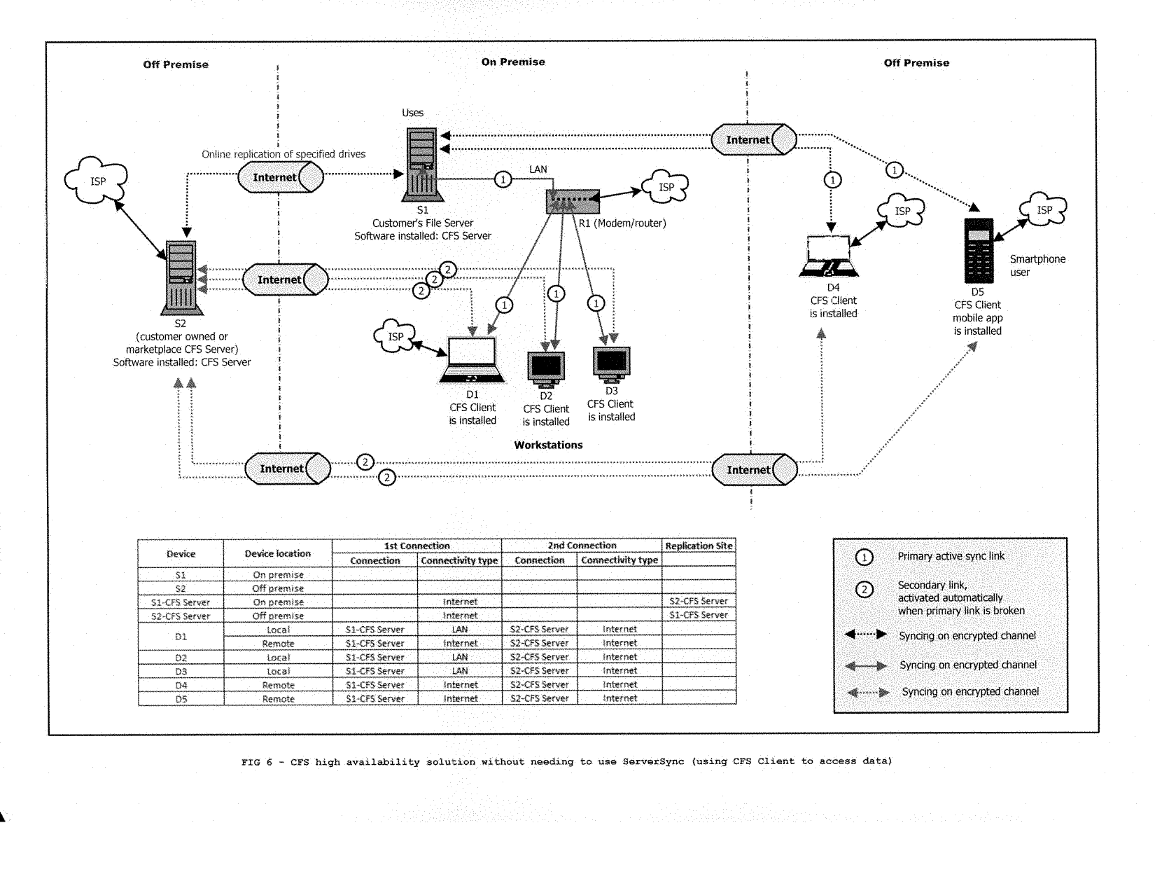

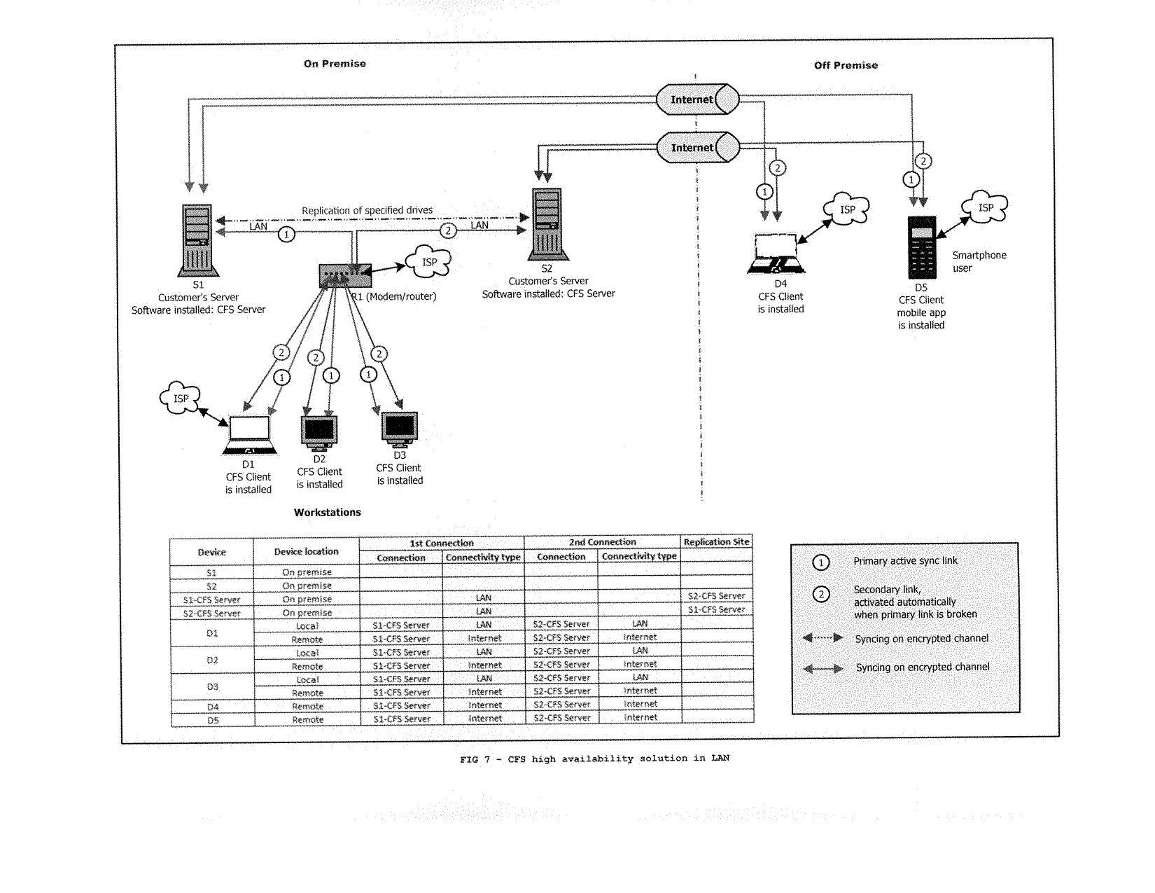

The embodiment illustrated in FIG. 8 highlights the High Availability (HA) file sharing and synchronization topology architecture in the most general form, where a plurality of CFS Servers is installed on multiple servers outside a company's premises. The key innovation here is that regardless of failure of an individual communications link, file synchronization and data sharing can continue automatically. As illustrated in FIG. 8, the primary active file synchronization link 1 is between workstations D1, D2, D3 and Server S1, all located within the company premises, where connection takes place through the company's internal LAN. When this link is broken, the secondary active link 2 between workstations D1, D2, D3 and Server S2 through the internet is automatically invoked. Similar is the case for active links 3 and 4. There is data replication of selected drives in each of Server S2, Server S3 and Server S4. Data is synchronized between Server S1 and Server S2; Server S2 and Server S3; Server S3 and Server S4, and so forth.

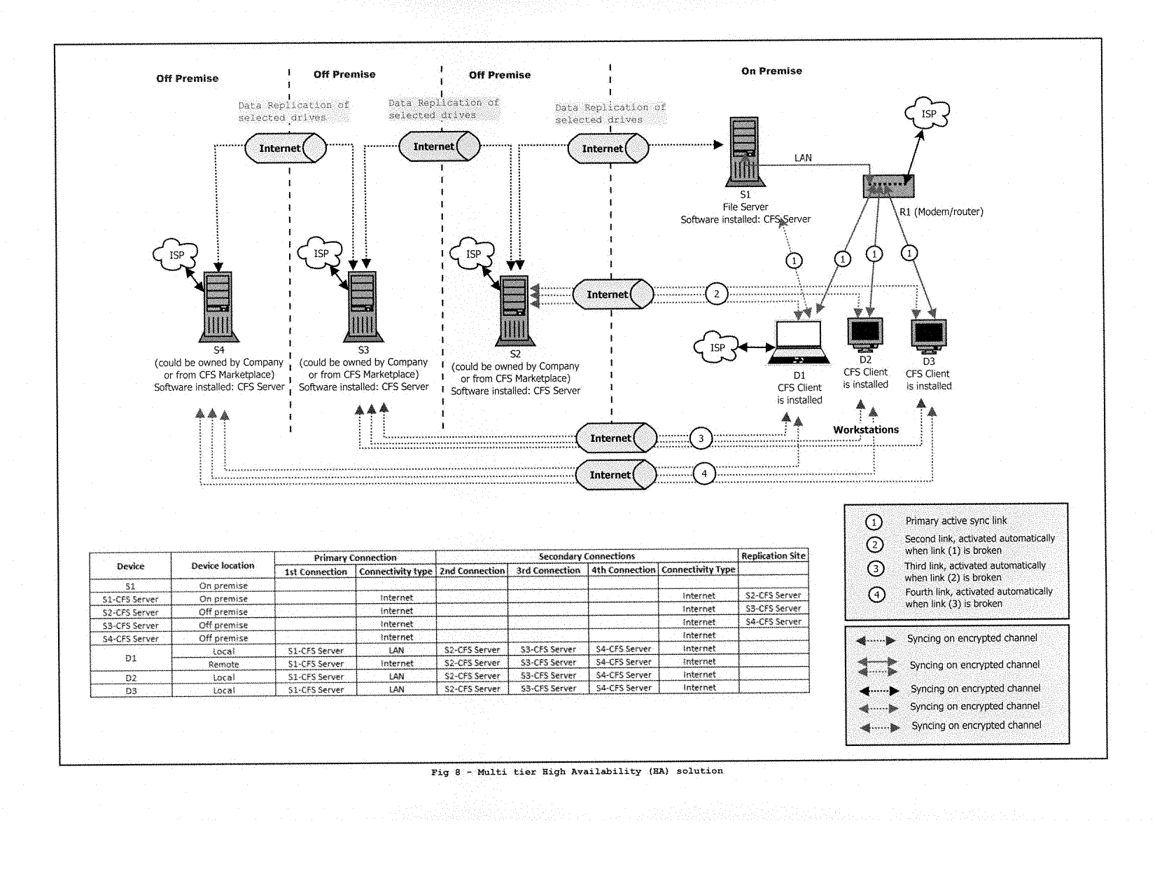

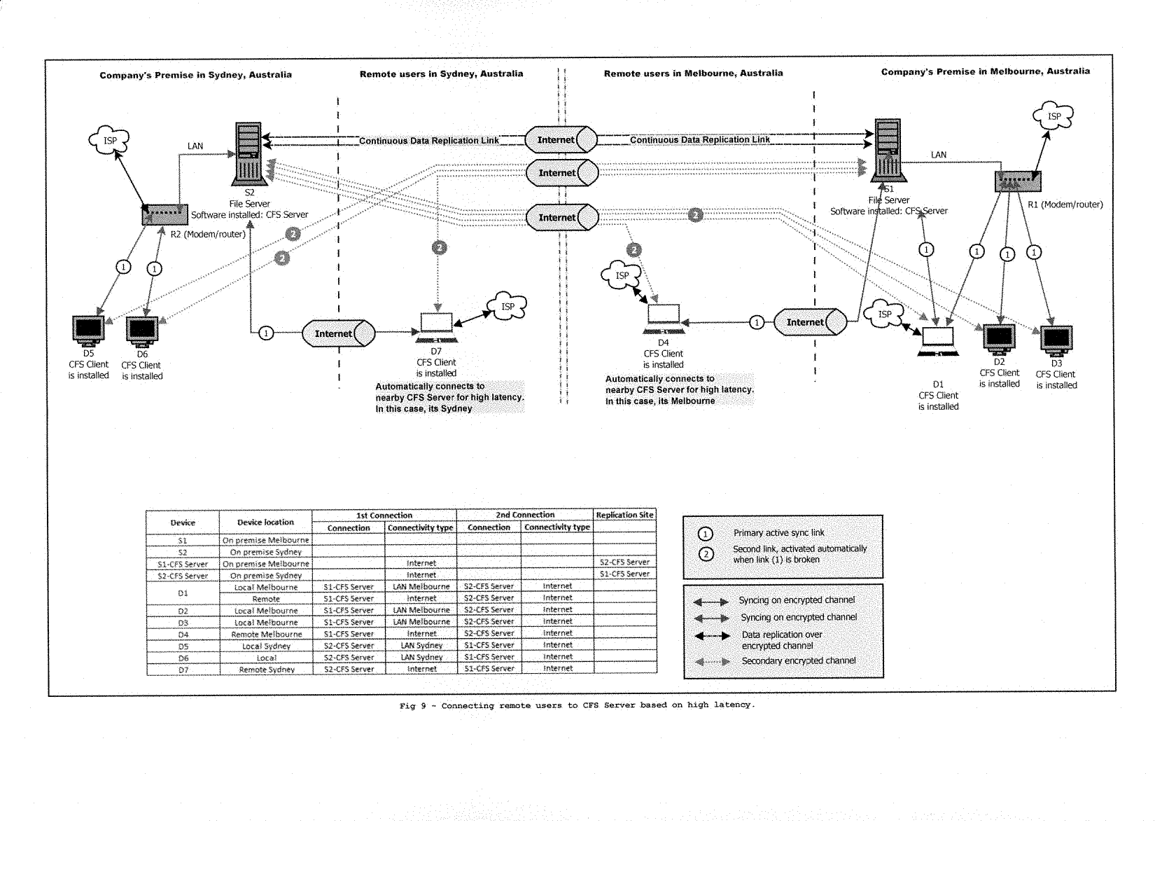

The embodiment illustrated in FIG. 9 highlights the scenario in a High Availability (HA) topology architecture where connections between remote users occur with CFS Server based on their physical locations. As illustrated in FIG. 9, a company has two physical premises—one in Melbourne, Australia and the other in Sydney, Australia. All workstations D1, D2, D3, D4, D5, D6 and D7 have CFS Client installed. The Servers S1 and S2 have CFS Server installed. Workstation D1 is connected to Server S1 via the internet, and the two local Melbourne office workstations D2 and D3 are connected to Melbourne office Server S1 via the LAN. The two local Sydney office workstations D5 and D6 are connected to the Sydney office Server S2. All connections are primarily provided through the internal company LAN. There is a continuous data replication link between Server S1 and Server S2 through the internet, as illustrated in FIG. 9. A remote user with workstation D4 has CFS Client installed. If workstation D4 is physically closest to the Sydney office then connection is to Server 2, however, if the physical location becomes closer to the Melbourne office, then connection will automatically connect to the Melbourne office Server S1 through the internet. Similarly, applies for the remote workstation D7. The primary active link 1 is as illustrated in FIG. 9, between {workstations D5, D6, D7 and Server S2} and {workstations D1, D2, D3, D4 and Server S1}. Referencing in absolute the embodiment described in FIG. 8, upon failure of link 1 on the company premises in Sydney, workstations D5 and D6 automatically connect directly to the Melbourne based Server S1 through the internet, as does remote workstation D7. Similar applies for a failure of link 1 on the company premises in Melbourne.

### Section 5.4 Inventive Steps

There is no single point of failure in this invention's embodiment of file synchronization and data sharing, which is a departure from referenced prior art. The mechanisms described in this invention ensure continuous data sharing between devices irrespective of any communications link or intermediate linked device failure.

There is no shared namespace in this invention's embodiment of file synchronization and data sharing, which is a further departure from referenced prior art. The mechanisms described in this invention ensure that server physical location is irrespective to delivering continuous file sharing and data synchronization between pluralities of end user devices.

The mechanisms described in this invention involve physical data communications between synchronized devices as opposed to metadata communications existing in referenced prior art, which is a further departure of note.

The mechanisms described in this invention ensure efficiency in file synchronization and data sharing through precise identification of the server on which relevant data blocks reside that is of interest to a particular client. In the most general embodiment as illustrated in FIG. 6, a local workstation residing in Company A's premises knows exactly which of Server S1, Server S2, Server S3 and Server S4 holds the physical instance of the file that it requires. It can thus query the relevant server directly. This is a further point of departure from referenced prior art where clients send a general query to the linked servers which is then mapped and decoded to identify the relevant server which has the physical file resident on it.

The mechanisms described in this invention ensure that file links synchronize the metadata with physical data by clicking on those links. It is possible to convert a file to a link in this invention and have the same inventive functionalities as discussed. A further point of departure from referenced prior art is the ability to convert a file to a link and vice versa at any time, as well as enabling automatic conversion of a file to a link based on system administration policies (e.g. non-use of a file for 30 days).

### Section 5.5 Inventive Steps—Embodiment of File to Link Inter-Conversion

The mechanisms described in this invention can be utilized to develop inventive steps concerning the embodiment of file to link inter-conversion. This invention applies to synchronizing metadata associated with a particular file, and synchronizing the metadata across a plurality of server-client associated pair devices. Whenever a user on this client workstation opens the concerned file link, the client workstation sends a request to the associated server and the file is downloaded on the client workstation from the server. The file thus exists as a real physical file on that corresponding client workstation. The user, alternatively, can request real files to be downloaded on the client workstation and have them available offline, in which case, the physical files are fetched and stored on that corresponding client workstation. The user has complete control over the file to link inter-conversion process. Should the user delete the file from the local workstation, the file is deleted from that machine but is retained on the corresponding server's retention area in the said network topology. As stated in the previous section citation, the system administrator of the client also has the ability to automatically convert stored physical files on a client workstation to links after a policy-based time has elapsed in the absence of activity on those said physical files.

Yet another inventive step described in this invention is the ability to lock and unlock individual file links by a user. After a file to a link conversion, an encryption technique could be applied on the said link to lock it, which could only be unlocked through the use of the corresponding decryption key.

Different embodiments of invention in prior art have addressed file to link inter-conversion processes using different approaches, with most inventions not addressing the key inventive step outlined in this invention. A list of such prior art is compiled below to highlight the key differences of invention in prior art with that outlined in this invention.

### a) Patent Application Number: WO2016053518

Patent Title: Methods and Systems for Portably Deploying Applications on one or more Cloud Systems

Patent Applicant: Sony Computer Entertainment America LLC

International Filing Date: 27 Aug. 2015

Patent Summary Extract: “Methods and systems for provisioning services or resources on a cloud service for successful execution of an application includes detecting a request for executing an application on a cloud service. In response to the request, a descriptor record for the application is retrieved from a descriptor file. The descriptor record is specific for the cloud service and provides details of environmental resources or services required for executing the application. Resource and service requirements are translated into actions to be taken in the cloud service environment for provisioning the resources or services required for the application. The actions to be taken are brokered to occur in pre-defined sequence based on details provided in the descriptor record for the application. Status of the actions taken is provided. The status is used to determine if the required resources or services have been provisioned for successful execution of the application in the cloud service.”

Key Point of Difference with this Invention: No use of file links, synchronization takes place through file descriptor records

### b) Patent Application Number: US20150347453

Patent Title: System and Method of Implementing an Object Storage Infrastructure for cloud-based services

Patent Applicant: Egnyte Inc.

Patent Application Date: 12 Aug. 2015

Patent Summary Extract: “A method for storing objects in an object storage system includes the steps of establishing a network connection with a client over an inter-network, receiving an upload request indicating an object to be uploaded by the client, selecting at least two storage nodes on which the object will be stored, receiving the object from the client via the network connection, and streaming the object to each of the selected storage nodes such that the object is stored on each of the selected storage nodes. The method can also include writing an object record associating the object and the selected storage nodes to a shard of an object database and generating a Universally Unique Identifier (UUID). The UUID indicates the shard and the object ID of the object record, such that the object record can be quickly retrieved. Object storage infrastructures are also disclosed.”

Key Point of Difference with this Invention: No use of file links, synchronization takes place through object records and respective identifiers

### c) Patent Application Number: US20160065627

Patent Title: Configurable Metadata-based Automation and Content Classification

Architecture for cloud-based collaboration platforms

Patent Applicant: Box Inc.

Patent Application Date: 29 Aug. 2014

Patent Summary Extract: “Scalable architectures, systems, and services are provided herein for generating jobs by applying user-specified metadata rules to metadata events. More specifically, the scalable architecture described herein uses metadata to drive automations and/or polices in a cloud-based environment. In one embodiment, the architecture integrates a metadata service with an event-based automation engine to automatically trigger polices and/or automations based on metadata and/or changes in metadata changes. The metadata service can include customizable and/or pre-build metadata templates which can be used to automatically apply a metadata framework (e.g., particular fields) to files based on, for example, the upload or placement of a particular file in a particular folder. The architecture also provides for advanced metadata searching and data classification.”

Key Point of Difference with this Invention: No use of file links, synchronization takes place through metadata framework

### d) Patent Application Number: US20160072922

Patent Title: Managing Edits of Content Items

Patent Applicant: Dropbox Inc.

Patent Application Date: 9 Sep. 2014

Patent Summary Extract: “One or more embodiments provide features for managing and editing content items. In particular, one or more embodiments enable one or more users to access and modify content items from one of multiple client devices without requiring storage of the content item locally on the client device. Additionally, one or more embodiments enable storing reduced resolution content items on multiple client devices in a way that saves storage space on the client devices while providing access to a content item without requiring constant network access to a central system. Further, one or more embodiments enable globally applying local edits to a content item and corresponding reduced resolution content items on multiple client devices.”

Key Point of Difference with this Invention: No embodiment of policy-based and automated file to link inter-conversion while synchronization of metadata and physical files

### e) Patent Application Number: US20160026348

Patent Title: System, Method and Computer Program for enabling a user to synchronize, manage, and share folders across a plurality of client devices and a synchronization server

Patent Applicant: Dropbox Inc.

Patent Application Date: 1 Oct. 2015

Patent Summary Extract: “A system, method, and computer program are provided for enabling a user to synchronize, manage, and share files and folders across a plurality of client devices and a synchronization server. In a user interface, a first view displays all folders, which a user has synchronized to the synchronization server and a drop-target zone to which the user is able to drag a folder from the local device to synchronize the folder with the synchronization server. A second view displays all files and folders, which the user has shared with other users. A third view displays a list of user contacts, where each contact is a drop-target zone on which a user is able to drag a folder to share the folder with the contact. A fourth view is provided in which a user is able to see activity related to a folder displayed in the first view.”

Key Point of Difference with this Invention: No embodiment of file to link inter-conversion while synchronization of files and metadata

### f) Patent Application Number: US20160110326

Patent Title: Collaborative Document Editing using State-based Revision

Patent Applicant: Microsoft Corporation

Patent Application Date: 15 Apr. 2014

Patent Summary Extract: “The present disclosure provides methods, systems, and computer products for providing state-based revisions in a document collaboration system. In some aspects, a plurality of users may be simultaneously editing the same document on their respective computing devices. The document may comprise a plurality of editable objects having unique objects identifiers. In such aspects, when a user edits an object in a local version of the document, a state-based revision (“SBR”) record is created. The SBR is populated with information such as, information describing the type of object being edited, a descriptor that uniquely identifies the specific instance of the object being edited, and a collection of common references that can be adjusted by the document collaboration engine and an opaque binary stream comprising the modified state of the edited object. The SBR record is then transmitted to one or more additional devices.”

Key Point of Difference with this Invention: No embodiment of files and links.

1. Methods and techniques for transferring of metadata in a reliable, seamless and fault-tolerant manner between a plurality of clients and servers

2. Methods and techniques to transfer shared data between devices seamlessly in the event of failure of a plurality of links between them, as derived from claim 1.

3. Methods and techniques to retrieve stored data from a particular server identified by the client from a plurality of servers, as derived from claim 1.

4. Methods and techniques of managing the sharing of metadata and associated physical data through link conversions to files and vice versa, as derived from claim 1.

5. Methods and techniques to implement incremental data synchronization of files as derived from claims 1 and 3.

6. Methods and techniques to implement integrated backup solutions to complement the High Availability (HA) solution derived from claim 3.
